(19) United States
(12) Patent Application Publication
(10) Pub. No.: US 2020/0383492 A1
(43) Pub. Date: Dec. 10, 2020

(54) FLOATING MATTRESS CAPABLE OF SUPPORTING AT LEAST ONE USER OR ONE OBJECT ON THE WATER THANKS TO THE BUOYANCY THEREOF

(71) Applicant: COZIP, CALUIRE ET CUIRE (FR)

(72) Inventor: INGRID PERELLE, FONTAINES SAINT MARTIN (FR)

(21) Appl. No.: 16/772,455

(22) PCT Filed: Dec. 11, 2018
(86) PCT No.: PCT/FR2018/053182

§ 371 Date: Jun. 12, 2020

(30) Foreign Application Priority Data
Dec. 13, 2017 (FR) 17/62092

(51) Int. Cl. A47C 27/15; B63B 34/50; A47C 15/00; B32B 5/32

(52) U.S. Cl. CPC A47C 27/15; B63B 34/50; A47C 15/006; B32B 2307/726; B32B 2266/06; B32B 2266/08; B32B 2307/72; B32B 5/32

(57) ABSTRACT

A floating mattress capable of supporting at least one user or one object on the water, comprising a set of foam layers, the set of foam layers comprising a plurality of foam layers including at least one first buoyancy layer comprising a first foam composition, the first buoyancy layer being intended to be positioned opposite to the surface of the water and a second comfort layer comprising a second foam composition, the second comfort layer being intended to be opposite to the at least one user or object.

### FIELD OF THE INVENTION

The present invention relates generally to a floating mattress capable of supporting at least one user or one object on the water thanks to the buoyancy thereof.

### PRIOR ART

In order to allow an individual or an object to float on the water, the floating mattress must have a sufficient buoyancy to support the weight of an individual or an object. A known application of a floating mattress are the floating mattresses constituted of a solid foam with closed cells.

The problem with this type of floating mattress is the lack of comfort. Because of the rigidity of the solid foam with closed cells, a discomfort may appear during use.

The prior art includes the document WO patent no. 2017/013546 describing a mattress composed of a single floating body constituted of a solid foam with closed cells.

No solution of the state of the art allows providing fully satisfactory techniques allowing a comfortable use of a floating mattress.

The present invention aims at solving all or part of the drawbacks mentioned above.

### DISCLOSURE OF THE INVENTION

To this end, the present invention concerns a floating mattress capable of supporting at least one user or one object on the water, comprising a set of foam layers, the set of foam layers comprising a plurality of foam layers including at least one first buoyancy layer comprising a first foam composition, the first buoyancy layer being intended to be positioned opposite to the surface of the water and a second comfort layer comprising a second foam composition, the second layer being intended to be opposite to the at least one user or object.

According to one embodiment, the volume of the first buoyancy layer must be at least 5000 cm³.

The volume of the first buoyancy layer depends on the weight to be supported by the mattress.

The higher the weight is and the greater the volume of the first buoyancy layer should be.

According to one embodiment, the volume of the first buoyancy layer is greater than 15000 cm³.

According to one embodiment, the volume of the first buoyancy layer is greater than 50000 cm³.

According to one embodiment, the volume of the first buoyancy layer is greater than 100000 cm³. According to one embodiment, the thickness of the buoyancy layer is greater than 2 cm.

According to one embodiment, the thickness of the buoyancy layer is comprised between 5 and 10 cm.

According to one embodiment, the thickness of the buoyancy layer is greater than 10 cm.

According to one embodiment, the first buoyancy layer has a constant thickness over its entire surface.

According to one embodiment, the first buoyancy layer has at least one first portion and at least one second portion, the thickness of the buoyancy layer being greater in the first portion relative to the thickness in the second portion.

Thanks to these arrangements, the mattress can be adapted to the distribution of the weight of a user or an object without imposing a significant thickness on the entire surface.

According to one embodiment, said first portion is disposed in an area of the mattress intended to receive the upper portion of the body of a user.

The buoyancy layer consists of a rigid foam with closed cells.

According to one embodiment, the term «rigid foam with closed cells» is understood as the material is a foam made from solid closed cells.

According to one embodiment, these cells are created from a gas and contain gas or air. These aspects contribute to the buoyancy of the mattress.

According to one embodiment, the foam can be made from several materials such as:
a polyurethane foam;
a rubber foam;
an extruded polystyrene foam;
a polystyrene foam; and
a phenolic foam.

According to one embodiment, the buoyancy layer with closed cells is impermeable. This allows a high coefficient of buoyancy.

The comfort layer consists of an anti-humidity waterproof flexible foam with open cells.

According to one embodiment, the term «flexible foam with open cells» is understood as the material is a foam made from flexible open cells.

According to one embodiment, a flexible foam allows a great comfort.

According to one embodiment, the comfort layer consists of an anti-humidity waterproof flexible foam with open cells, which allows it to let pass water as well as air.

According to one embodiment, the comfort layer consists of an anti-humidity waterproof flexible foam with open cells which allows it to accelerate the drying and to prevent the development of molds.

The comfort layer can include at least one housing intended for the reception of the at least one object.

According to one embodiment, said housing is open on one face of the comfort layer oriented opposite to the buoyancy layer.

According to one embodiment, the at least one object received in the at least one housing can be a cup or any other container.

A third layer including a third flexible foam composition is mounted on a face of the comfort layer oriented opposite to the buoyancy layer.

According to one embodiment, the third foam layer allows performing different functions such as that of headrest for example.

According to one embodiment, the third foam layer including a third foam composition has a composition identical to the composition of the foam of the comfort layer.

At least two foam layers adjacent to the set of foam layers are linked to each other by securing the adjacent faces thereof.

According to one embodiment, said adjacent faces are linked to each other by a water-resistant glue for example.

According to one embodiment, the use of a water-resistant glue allows maintaining, over the long term, the solidarity of the different layers composing the mattress taking into account the environment of use.

The floating mattress comprises a resistant protective cover adapted for the evacuation of the stored water, the protective cover is intended to envelop the set of foam layers.

According to one embodiment, the protective cover includes at least two portions of fabric. The first portion of fabric covers the buoyancy layer of the mattress while the second portion of fabric covers at least the comfort layer of the mattress.

According to one embodiment, the second portion of fabric of the protective cover is water-repellent or impermeable.

According to one embodiment, the first portion is permeable in order to allow the evacuation of the water likely to infiltrate between the different foam layers of the set of foam layers and thus to avoid the development of molds.

According to one embodiment, the protective cover is detachable from the set of foam layers.

According to one embodiment, the protective cover comprises one or more closure element(s) such as a zipper or even a hook and loop fastening strip for example.

According to one embodiment, the protective cover is resistant to certain elements such as UV, open air or water for example.

The first foam composition has a density comprised between 10 kg/m² and 85 kg/m².

According to one embodiment, the first foam composition has a longitudinal tensile strength comprised between 0.10 N/mm² and 0.80 N/mm²;

According to one embodiment, the first foam composition has a transverse tensile strength comprised between 0.10 N/mm² and 0.80 N/mm²;

According to one embodiment, the first foam composition has an elongation at longitudinal break comprised between 50% and 120%.

According to one embodiment, the first foam composition has an elongation at transverse break comprised between 50% and 100%.

According to one embodiment, the first foam composition has a longitudinal tear strength comprised between 500 N/m and 6000 N/m.

According to one embodiment, the first foam composition has a transverse tear strength comprised between 1000 N/m and 6000 N/m.

According to one embodiment, the first foam composition has a compressive strength for 40% of deformation comprised between 5 kPa and 100 kPa.

According to one embodiment, the first foam composition has a thermal stability for an exposure to 70° C. over a period of 24 hours creating a deformation of less than 10%.

The different mentioned features are important in order to guarantee a solidity, a buoyancy and an optimal life expectancy.

The second foam composition has a density included between 10 kg/m² and 40 kg/m².

The second foam composition has a number of cells comprised between 2/cm and 8/cm.

According to one embodiment, the second foam composition has a tensile strength comprised between 1 kPa and 10 kPa.

According to one embodiment, the second foam composition has an elongation at longitudinal break comprised between 50% and 200%.

According to one embodiment, the second foam composition has a compressive strength for 10% of deformation comprised between 1 kPa and 20 kPa.

According to one embodiment, the used protective cover has one or more of the following features:
a composition in composite PVC and synthetic fibers;
a weight comprised between 250 g/m² and 750 g/m²;
a porosity comprised between 0% and 20%;
a breaking strength comprised between 50 daN/5 cm and 400 daN/5 cm, and
a tear strength comprised between 20 daN and 100 daN.

According to one embodiment, the different mentioned features are intended to guarantee a solidity, a comfort and improved life expectancy of the invention.

According to one embodiment, the body of the mattress has a length comprised between 1.2 m and 3 m, a width comprised between 0.5 m and 2.5 m, a thickness comprised between 0.05 m and 0.75 m. The different non-incompatible aspects defined above can be combined.

The invention also concerns a floating mattress capable of supporting at least one user on the water, comprising a set of foam layers, the set of foam layers comprising a plurality of foam layers including at least one first buoyancy layer comprising a first foam composition, the first buoyancy layer being intended to be positioned in contact with the surface of the water and a second comfort layer comprising a second foam composition, the second layer being intended to be opposite to the at least one user or object.

### BRIEF DESCRIPTION OF THE FIGURES

The invention will be better understood using the detailed description which is exposed below with regard to the appended drawing in which:

FIG. 1 represents a first floating mattress in a cross-sectional view in accordance with the present invention;

FIG. 2 represents the floating mattress of FIG. 1 in top view in accordance with the present invention; and

FIG. 3 represents a second floating mattress in a cross-sectional view in accordance with the present invention.

### DESCRIPTION WITH REFERENCE TO THE FIGURES

The invention will be better understood using the detailed description which is exposed below with regard to the appended drawing.

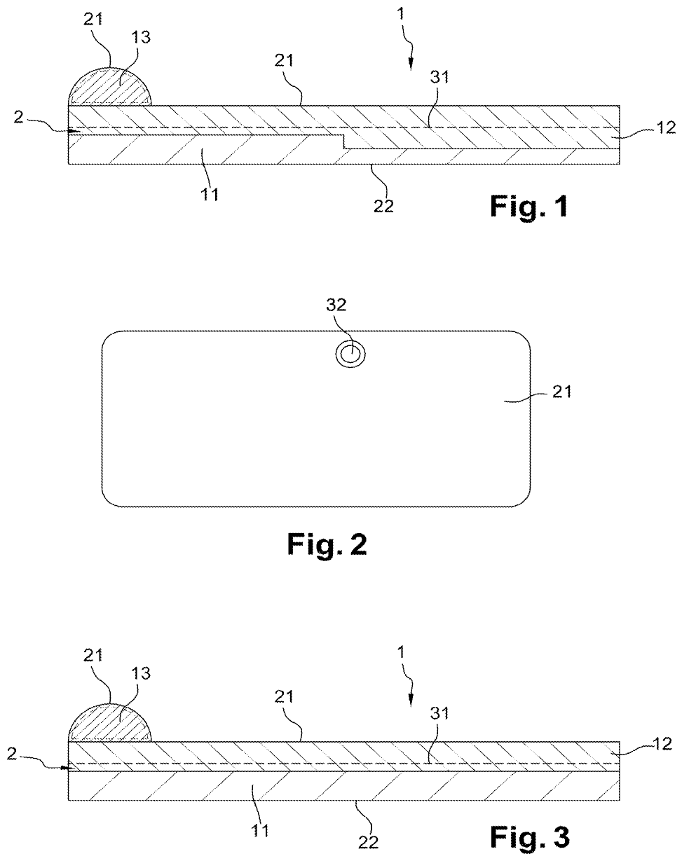

According to a first embodiment illustrated in FIGS. 1 and 2, the floating mattress 1 capable of supporting at least one user or one object on the water, comprises a set of foam layers 2 in which at least two foam layers adjacent to the set of foam layers 2 are linked to each other by securing the adjacent faces thereof. Said adjacent faces are linked to each other by a water-resistant glue for example. The use of a water-resistant glue allows maintaining, over the long term, the solidarity of the different layers composing the mattress taking into account the environment of use.

The set of foam layers 2 comprises a plurality of foam layers including at least one buoyancy layer 11 and a comfort layer 12.

The buoyancy layer 11 is intended to be positioned opposite to the surface of the water. It comprises a first composition of rigid foam with closed cells. The term «rigid foam with closed cells» is understood as the material is a foam made from solid closed cells. These cells are created from a gas and contain gas or air. The rigid foam with closed cells is impermeable, which gives it a high coefficient of buoyancy. It can be made from several materials such as a polyurethane foam, a rubber foam, an extruded polystyrene foam, a polystyrene foam or else a phenolic foam.

These different aspects contribute to the buoyancy of the mattress 1.

The comfort layer 12 comprises a second composition of cross-linked foam, which allows it to let pass water as well as air, accelerate the drying and prevent the development of moulds. In other words, the foam is an anti-humidity waterproof flexible foam and with open cells. The term «flexible foam with open cells» is understood as the material is a foam made from flexible open cells. The comfort layer 12 being intended to be opposite to at least one user or object.

These different aspects contribute to a great comfort in using the floating mattresses 1.

As illustrated in FIG. 1, a third layer 13 including a flexible foam composition identical to that of the comfort layer mounted on a face of the comfort layer 12 oriented opposite to the buoyancy layer 11. This third foam layer allows performing different functions such as that of headrest for example.

The floating mattress 1 comprising a resistant protective cover 21 adapted for the evacuation of the stored water, the protective cover being intended to envelop the set of foam layers 2, it is however detachable from the set of foam layers 2. To do this, the protective cover comprises one or more closure element(s) such as a zipper or even a hook and loop fastening strip for example. This allows facilitating the maintenance of the floating mattress 1.

The protective cover is resistant to certain elements such as UV, open air or water for example.

The protective cover 21 includes at least two portions of fabric. The first portion of fabric covers the buoyancy layer of the mattress while the second portion of fabric covers at least the comfort layer of the mattress.

The first portion of the protective cover 21 is permeable in order to allow the evacuation of the water likely to infiltrate between the different foam layers of the set of foam layers 2 and thus to avoid the development of molds.

The second portion of fabric of the protective cover is water-repellent or impermeable.

As illustrated in FIG. 2, the comfort layer 12 of the mattress 1, may include a housing 32 intended for the reception of at least one object such as a cup or any other container. Said housing 32 is open on a face of the comfort layer 12 oriented opposite to the buoyancy layer 11.

The first foam composition has a density comprised between 10 kg/m² and 85 kg/m², a longitudinal tensile strength comprised between 0.10 N/mm² and 0.80 N/mm², a transverse tensile strength comprised between 0.10 N/mm² and 0.80 N/mm², an elongation at longitudinal break comprised between 50% and 120%, an elongation at transverse break comprised between 50% and 100%, a longitudinal tear strength comprised between 500 N/m and 6000 N/m, a transverse tear strength comprised between 1000 N/m and 6000 N/m, a compressive strength for 40% of deformation comprised between 5 kPa and 100 kPa, a thermal stability for an exposure to 70° C. over a period of 24 hours creating a deformation of less than 10%.

The different mentioned features are important in order to guarantee a solidity, a buoyancy and an optimal life expectancy.

The second foam composition has a density included between 10 kg/m² and 40 kg/m², a number of cells comprised between 2/cm and 8/cm, a tensile strength comprised between 1 kPa and 10 kPa, an elongation at longitudinal break comprised between 50% and 200%, a compressive strength for 10% of deformation comprised between 1 kPa and 20 kPa, a composition in composite PVC and synthetic fibers, a weight comprised between 250 g/m² and 750 g/m², a porosity comprised between 0% and 20%, a breaking strength comprised between 50 daN/5 cm and 400 daN/5 cm, a tear strength comprised between 20 daN and 100 daN.

The different mentioned features are intended to guarantee a solidity, a comfort and improved life expectancy of the invention.

The volume of the first buoyancy layer must be at least 5000 cm³.

The volume of the first buoyancy layer depends on the weight to be supported by the mattress.

The higher the weight is and the greater the volume of the first buoyancy layer should be.

According to one embodiment, the volume of the first buoyancy layer is greater than 15000 cm³.

According to one embodiment, the volume of the first buoyancy layer is greater than 50000 cm³.

According to one embodiment, the volume of the first buoyancy layer is greater than 100000 cm³. According to one embodiment, the thickness of the buoyancy layer is greater than 2 cm.

According to one embodiment, the thickness of the buoyancy layer is comprised between 5 and 10 cm.

The first buoyancy layer has a constant thickness over its entire surface.

As illustrated in FIGS. 1 and 2, the body of the mattress has a length comprised between 1.2 m and 3 m, a width comprised between 0.5 m and 2.5 m, a thickness comprised between 0.05 m and 0.75 m.

According to a second embodiment illustrated in FIG. 3, the mattress comprises the same elements as those described for the first embodiment.

However, this embodiment differs in that the first buoyancy layer has at least one first portion and at least one second portion, the thickness of the buoyancy layer being greater in the first portion relative to the thickness in the second portion.

Thanks to these arrangements, the mattress can be adapted to the distribution of the weight of a user or an object without imposing a significant thickness on the entire surface.

Said first portion is disposed in an area of the mattress intended to receive the upper portion of the body of a user.

Of course, the invention is not limited to the embodiments represented and described above, but covers, on the contrary, all variants thereof.

1. A floating mattress for supporting at least one user or one object on water, comprising:
a set of foam layers, the set of foam layers comprising a plurality of foam layers including at least one first buoyancy layer comprising a first foam composition, the first buoyancy layer being positioned opposite to a surface of the water and a second comfort layer comprising a second foam composition, the second layer being opposite to the at least one user or object.

2. The floating mattress according to claim 1, wherein the buoyancy layer comprises a rigid foam with closed cells.

3. The floating mattress according to claim 1, wherein the comfort layer comprises an anti-humidity waterproof flexible foam with open cells.

4. The floating mattress according to claim 1, wherein the comfort layer includes at least one housing for the reception of the at least one object.

5. The floating mattress according to claim 1, wherein a third layer including a third flexible foam composition is mounted on a face of the comfort layer oriented opposite to the buoyancy layer.

6. The floating mattress according to claim 1, wherein at least two foam layers adjacent to the set of foam layers are linked to each other by securing the adjacent faces thereof.

7. The floating mattress according to claim 1, comprising a resistant protective cover for evacuation of stored water, the protective cover enveloping the set of foam layers.

8. The floating mattress according to claim 1, wherein the first foam composition has a density comprised between 10 kg/m² and 85 kg/m².

9. The floating mattress according to claim 1, wherein the second foam composition has a density included between 10 kg/m² and 40 kg/m².

10. The floating mattress according to claim 1, wherein the second foam composition has a number of cells comprised between 2/cm and 8/cm.

11. The floating mattress according to claim 2, wherein the comfort layer comprises an anti-humidity waterproof flexible foam with open cells.

12. The floating mattress according to claim 11, wherein the comfort layer includes at least one housing for the reception of the at least one object.

13. The floating mattress according to claim 12, wherein a third layer including a third flexible foam composition is mounted on a face of the comfort layer oriented opposite to the buoyancy layer.

14. The floating mattress according to claim 13, wherein at least two foam layers adjacent to the set of foam layers are linked to each other by securing the adjacent faces thereof.

15. The floating mattress according to claim 14, comprising a resistant protective cover for evacuation of stored water, the protective cover enveloping the set of foam layers.

16. The floating mattress according to claim 15, wherein the first foam composition has a density comprised between 10 kg/m² and 85 kg/m².

17. The floating mattress according to claim 16, wherein the second foam composition has a density included between 10 kg/m² and 40 kg/m².

18. The floating mattress according to claim 17, wherein the second foam composition has a number of cells comprised between 2/cm and 8/cm.

19. The floating mattress according to claim 2, wherein the comfort layer includes at least one housing for the reception of the at least one object.

20. The floating mattress according to claim 2, wherein a third layer including a third flexible foam composition is mounted on a face of the comfort layer oriented opposite to the buoyancy layer.
